(19) United States
(12) Patent Application Publication
(10) Pub. No.: US 2004/0145617 A1
(43) Pub. Date: Jul. 29, 2004

(54) Recording method, recording apparatus, computer-readable storage medium, and computer system

(75) Inventor: Hirokazu Nunokawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/682,813

(22) Filed: Oct. 10, 2003

(30) Foreign Application Priority Data
Oct. 15, 2002 (JP) 2002-300488

(51) Int. Cl. B41J 29/38

(52) U.S. Cl. 347/16

(57) ABSTRACT

It is an object of the present invention to provide a recording method for recording according to one of a plurality of recording modes, including the steps of determining a target record start position according to the recording mode, carrying a front end of a medium to be recorded up to the target record start position determined according to the recording mode, intermittently carrying the medium to be recorded by a carry amount corresponding to the recording mode, and carrying out recording to the front end.

### CROSS-REFERENCE TO RELATED APPLICATION

The present application claims priority upon Japanese Patent Application No. 2002-300488 filed on Oct. 15, 2002, which is herein incorporated by reference.

### BACKGROUND OF THE INVENTION

1. Field of the Invention

The present invention relates to recording methods and recording apparatuses for recording to a medium to be recorded such as paper. The present invention also relates to computer-readable storage media on which a program for controlling such recording apparatuses is recorded, and computer systems.

2. Description of the Related Art

Inkjet printers that intermittently eject a liquid such as ink are known as an example of recording apparatuses for recording information to a medium to be recorded (including media to be printed) such as paper, cloth, and film (for example, see JP 2002-103721A).

With such inkjet printers, after a paper has been carried to a predetermined position, images are printed onto the paper by repeating an operation of ejecting ink from nozzles moving in a scanning direction and an operation of carrying the paper by a predetermined carry amount in a carrying direction.

Among such inkjet printers, printers that carry out so-called borderless printing (printing in which images are formed from the front end of a paper without leaving a margin on the paper) are known. Even when borderless printing is performed, it is possible to choose from among a plurality of print modes with which to carry out printing.

With conventional inkjet printers, however, when performing borderless printing there is a problem that unnecessary ink is ejected depending on the print mode that is selected.

### SUMMARY OF THE INVENTION

The present invention was arrived at in light of the foregoing issues, and it is an object thereof to reduce wastefulness when a recording apparatus records to a recording medium.

One embodiment of the present invention is a recording method for recording according to one of a plurality of recording modes, comprising the steps of determining a target record start position according to the recording mode, carrying a front end of a medium to be recorded up to the target record start position determined according to the recording mode, intermittently carrying the medium to be recorded by a carry amount according to the recording mode, and carrying out recording to the front end.

Another embodiment of the present invention is a recording apparatus comprising a carrying mechanism for carrying a medium to be recorded in a carrying direction, and a support section that has a recessed section and a protruding section and that supports the medium to be recorded by the protruding section, wherein the recording apparatus is capable of recording a front end, in the carrying direction, of the medium to be recorded according to a plurality of recording modest when recording to the front end, recording is carried out using a plurality of nozzles that are arranged in opposition to the recessed section; and the nozzles used when starting recording to the front end are determined according to the recording mode.

Features and objects of the present invention other than the above will become clear by reading the description of the present specification with reference to the accompanying drawings.

### BRIEF DESCRIPTION OF THE DRAWINGS

In order to facilitate further understanding of the present invention and the advantages thereof, reference is now made to the following description taken in conjunction with the accompanying drawings wherein:

FIG. 1 is an explanatory diagram of the overall configuration of an inkjet printer;

FIG. 2 is a schematic diagram of a carriage area of the ink-jet printer;

FIG. 3 is an explanatory diagram of q carrying unit area of the inkjet printer;

FIG. 4 is a perspective view of the carrying unit area of the inkjet printer;

FIG. 5 is an explanatory diagram of the configuration of a linear encoder;

FIG. 6 is a timing chart showing the waveform of an output signal of the encoder;

FIG. 7 is an explanatory diagram showing the arrangement of nozzles;

FIG. 8 is an explanatory diagram showing the positional relationship between grooves and the nozzle groups;

FIG. 9 is an explanatory diagram of the method for printing a front end of a paper;

FIG. 10 is an explanatory diagram of when there is carry error (reference diagram);

FIG. 11A is an explanatory diagram showing the relationship between the position of the front end of the paper and the position of the nozzles, in which the carrying direction is viewed from the side, and FIG. 11B is an explanatory diagram showing the relationship between the position of the front end of the paper and the position of the nozzles, in which the carrying direction is viewed from above;

FIG. 12 is an explanatory diagram showing the relative positional relationship between the front end of the paper and the nozzles;

FIG. 13 is an explanatory diagram showing the case of overlap print mode;

FIG. 14 is an explanatory diagram showing the case of high resolution print mode;

FIG. 15 is a flowchart showing the sequence in which the paper is carried;

FIG. 16 is a diagram showing the positional relationship of the paper;

FIG. 17 is a flowchart showing how paper skew is corrected;

FIG. 18 is a diagram showing how paper skew is corrected, viewed from above;

FIG. 19 is an explanatory diagram showing the external configuration of a computer system;

FIG. 20 is a block diagram showing the configuration of the computer system;

FIG. 21 is an explanatory diagram showing the user interface; and

FIG. 22 is an explanatory diagram of the format of print data.

### DETAILED DESCRIPTION OF THE INVENTION

At least the following matters will be made clear by the explanation in the present specification and the description of the accompanying drawings.

First, a recording method for recording according to one of a plurality of recording modes, comprising the steps of determining a target record start position according to the recording mode, carrying a front end of a medium to be recorded up to the target record start position determined according to the recording mode, intermittently carrying the medium to be recorded by a carry amount according to the recording mode, and carrying out recording to the front end, will become clear.

According to this recording method, wastefulness when recording to the medium to be recorded can be reduced.

It is preferable that the recording method further includes the steps of detecting the front end of the medium to be recorded, and carrying the medium to be recorded based on a result of the detection of the front end of the medium to be recorded.

According to this recording method, the front end of the medium to be recorded can be positioned accurately.

In the recording method, it is preferable that the medium to be recorded is carried by a roller of a carrying mechanism, that the front end of the medium to be recorded is detected by a detector, and that the detector is provided downstream of the roller.

According to this recording method, the front end of the medium to be recorded can be positioned accurately.

In the recording method, it is preferable that the front end is detected after skew of the medium to be recorded has been corrected.

According to this recording method, the front end of the medium to be recorded can be positioned accurately.

In the recording method, it is preferable that the detector is provided in/on a carriage that makes a plurality of nozzles move in a scanning directions According to this recording method, the detector can be used for other application as well.

In the recording method, it is preferable that the medium to be recorded is supported by a support section that has a recessed section and a protruding section and that supports the medium to be recorded by the protruding section. It is also preferable that when carrying out recording to the front end, the target record start position is located between the recessed section and nozzles that are arranged in opposition to the recessed section.

According to this recording method, the front end can be recorded to without the support section supporting the medium to be recorded becoming dirty.

In the recording method, it is preferable that one of the recording modes is a mode in which a spacing in the carrying direction between two nozzles, among a plurality of nozzles, for ejecting liquid is wider than a spacing in the carrying direction between two dots, among a plurality of dots, formed on the medium to be recorded, and a row of dots that is not recorded exists between rows of dots that are recorded as the nozzles are moved once in a scanning direction.

According to this recording method, even if there is variation in the nozzle pitch or the ejection characteristics, the effect of these can be lessened, allowing the picture quality to be improved.

In the recording method, it is preferable that one of the recording modes is a recording mode in which one dot row formed on the medium to be recorded is recorded using a plurality of nozzles.

According to this recording method, even if there is variation in the nozzle pitch or the ejection characteristics, the characteristics of a particular nozzle can be kept from affecting an entire dot row, and therefore the picture quality can be increased.

In the recording method, it is preferable that printing is carried out to the medium to be recorded by carrying out recording to the medium to be recorded.

Furthermore, a printing method for printing according to one of a plurality of print modes includes the steps of determining a target print start position according to the print mode, carrying a front end of a medium to be printed up to the target print start position determined according to the print mode, intermittently carrying the medium to be printed by a carry amount according to the print mode, carrying out printing to the front end, detecting the front end of the medium to be printed, and carrying the medium to be printed based on a result of the detection of the front end of the medium to be printed, wherein the medium to be printed is carried by a roller of a carrying mechanism, the front end of the medium to be printed is detected by a detector, the detector is provided downstream of the roller, the front end is detected after skew of the medium to be printed has been corrected, the detector is provided in/on a carriage that makes a plurality of nozzles move in a scanning direction, the medium to be printed is supported by a support section that has a recessed section and a protruding section and that supports the medium to be printed by the protruding section, when carrying out printing to the front end, the target print start position is located between the recessed section and nozzles that are arranged in opposition to the recessed section, one of the print modes is a mode in which a spacing in the carrying direction between two nozzles, among a plurality of nozzles, for ejecting liquid is wider than a spacing in the carrying direction between two dots, among a plurality of dots, formed on the medium to be printed, and a row of dots that is not printed exists between rows of dots that are printed as the nozzles are moved once in the scanning direction, and another of the print modes is a print mode in which one dot row formed on the medium to be printed is printed using the plurality of nozzles, will become clear.

According to this printing method, the printing time when printing a medium to be printed can be shortened.

Also, such recording apparatuses, programs, and computer systems also fall within the scope of the present embodiment.

Next, a recording apparatus comprising a carrying mechanism for carrying a medium to be recorded in a carrying direction, and a support section that has a recessed section and a protruding section and that supports the medium to be recorded by the protruding section, wherein the recording apparatus is capable of recording to a front end, in the carrying direction, of the medium to be recorded according to a plurality of recording modes, when recording to the front end, recording is carried out using a plurality of nozzles that are arranged in opposition to the recessed section, and the nozzles used when starting recording to the front end are determined according to the recording mode, will become clear.

According to this recording apparatus, wastefulness when recording to the medium to be recorded can be reduced.

In the recording apparatus, it is preferable that after the front end of the medium to be recorded has been recorded, recording is carried out to the medium to be recorded using the plurality of nozzles that are arranged in opposition to the recessed section and a plurality of nozzles that are arranged in opposition to the protruding section.

According to this recording apparatus, liquid that is ejected from the nozzles in opposition to the protruding section lands on the medium to be recorded, and thus the medium to be recorded can be recorded to without the support section becoming dirty. Also, according to this recording apparatus, there is a greater number of nozzles used in recording, and thus the recording time can be shortened.

In the recording apparatus, it is preferable that, between an operation of intermittently carrying the medium to be recorded by a first carry amount and performing recording between those intermittent carries using the plurality of nozzles that are arranged in opposition to the recessed section, and an operation of intermittently carrying the medium to be recorded by a second carry amount and performing recording between those intermittent carries using the plurality of nozzles that are arranged in opposition to the recessed section and the plurality of nozzles that are arranged in opposition to the protruding section, there is an operation of intermittently carrying the medium to be recorded by the first carry amount and performing recording between those intermittent carries using the plurality of nozzles that are arranged in opposition to the recessed section and the plurality of nozzles that are arranged in opposition to the protruding section.

According to this recording apparatus, when shifting from front end recording to normal recording, it is possible to carry out recording to the medium to be recorded without there being gaps.

In the recording apparatus, it is preferable that the recording apparatus carries out recording to the medium to be recorded by repeating in alternation a carry operation in which the carrying mechanism carries the medium to be recorded and a recording operation in which liquid is ejected from the nozzles to form dots on the medium to be recorded, and that a carry amount by which the carrying mechanism carries the medium to be recorded when recording to the front end is wider than a spacing in the carrying direction between the dots.

According to this recording apparatus, so-called interlace printing is possible, and this allows recording to be carried out with high precision.

Overview of Printing Apparatus (Inkjet Printer)===

<Regarding the Configuration of the Inkjet Printer>

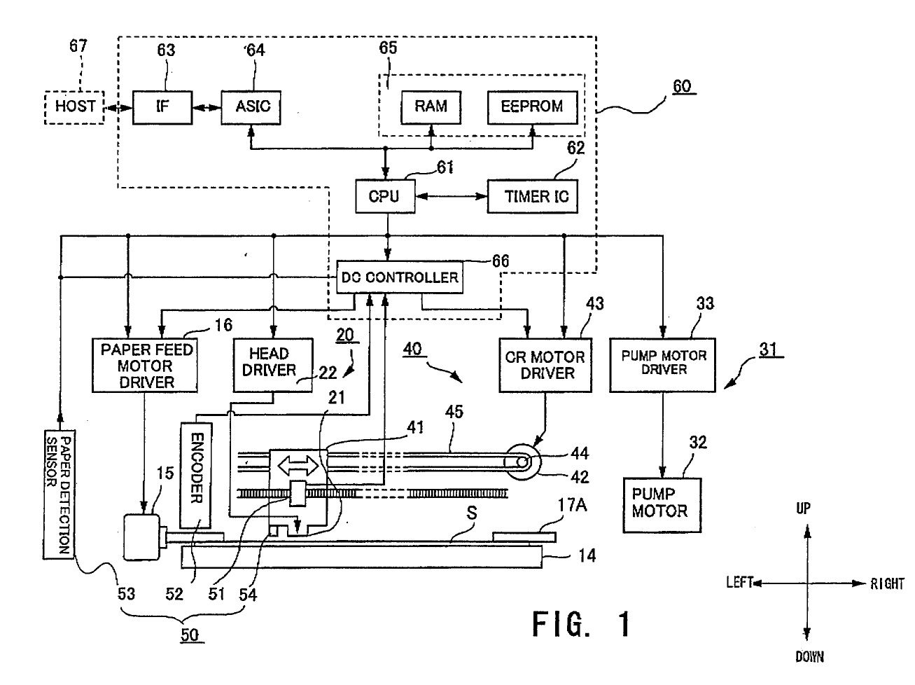

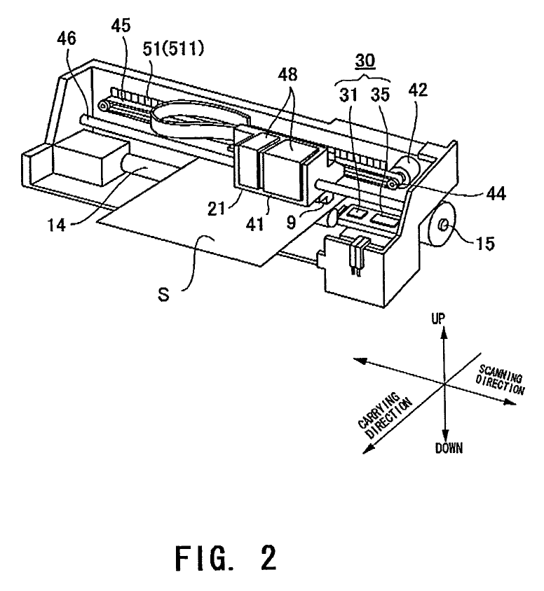

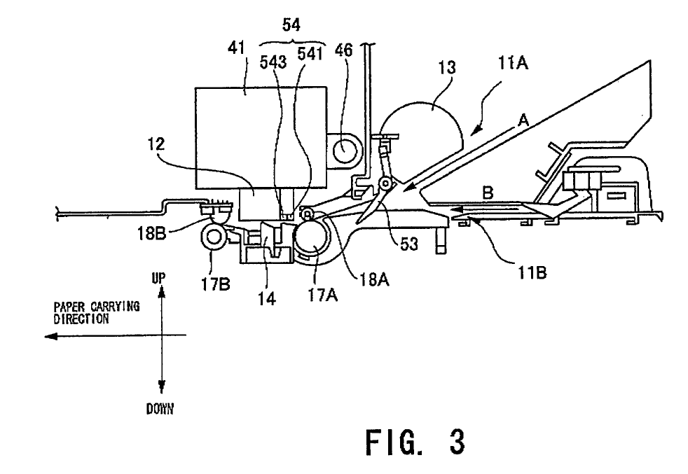

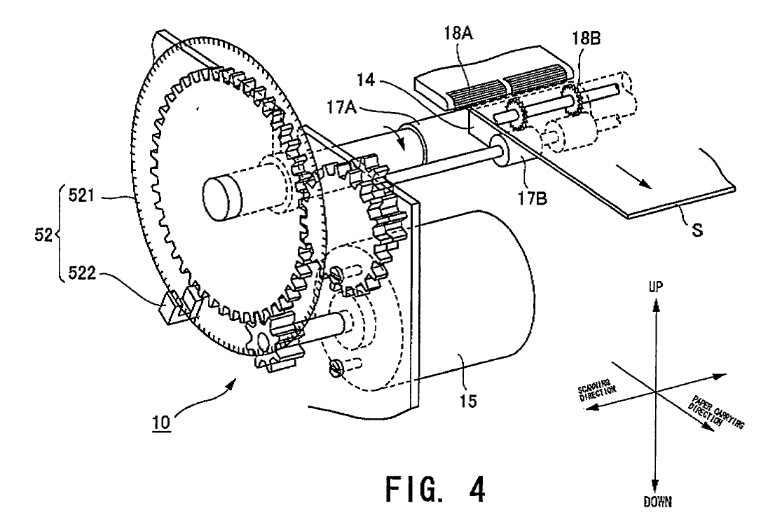

An overview of an inkjet printer serving as an example of a printing apparatus is described with reference to FIG. 1, FIG. 2, FIG. 3, and FIG. 4. It should be noted that FIG. 1 is an explanatory diagram of the overall configuration of an ink-jet printer of this embodiment, FIG. 2 is a schematic diagram of the carriage area of the inkjet printer of this embodiment, FIG. 3 is an explanatory diagram of a carrying unit area of the ink-jet printer of this embodiment, and FIG. 4 is a perspective view of the carrying unit area of the inkjet printer of this embodiment.

The inkjet printer of this embodiment has a paper carrying unit 10, an ink ejection unit 20, a cleaning unit 30, a carriage unit 40, a measuring instrument group 50, and a control unit 60.

The paper carrying unit 10 is for feeding paper, which is an example of a medium to be printed, into a printable position and making the paper move in a predetermined direction (the direction perpendicular to the paper face in FIG. 1 (hereinafter, referred to as a paper carrying direction)) by a predetermined shift amount during printing. In other words, the paper carrying unit 10 functions as a carrying mechanism for carrying paper. The paper carrying unit 10 has a paper insert opening 11A and a roll paper insert opening 11B, a paper supply motor (not shown), a paper supply roller 13, a platen 14, a paper feed motor (hereinafter, referred to as PF motor) 15, a paper feed motor driver (hereinafter referred to as PF motor driver) 16, a carry roller 17A and paper discharge rollers 17B, and free rollers 18S and free rollers 18B. However, the paper carrying unit 10 does not necessarily have to include all of these structural elements in order to function as a carrying mechanism.

The paper insert opening 11A is where paper, which is a medium to be printed, is inserted. The paper supply motor (not shown) is a motor for carrying the paper that has been inserted into the paper insert opening 11A into the printer, and is constituted by a pulse motor. The paper supply roller 13 is a roller for automatically carrying the paper that has been inserted into the paper insert opening 11A into the printer, and is driven by the paper supply motor 12. The paper supply roller 13 has a transverse cross-sectional shape that is substantially the shape of the letter D. The peripheral length of a circumference section of the paper supply roller 13 is set longer than the carrying distance to the PF motor 15, so that using this circumference section the medium to be printed can be carried up to the PF motor 15. It should be noted that a plurality of media to be printed are kept from being supplied at one time by the rotational drive force of the paper supply roller 13 and the friction resistance of separating pads (not shown). The sequence through which the medium to be printed is carried is described in detail later.

The platen 14 is a support section that supports a paper S during printing. The configuration of the platen 14 is described in detail later. The PF motor 15 is a motor for feeding paper, which is an example of a medium to be printed, in the paper carrying direction, and is constituted by a DC motor. The PF motor driver 16 is for driving the PF motor 15. The carry roller 17A is a roller for feeding the paper S that has been carried into the printer by the paper supply roller 13 to a printable region, and is driven by the PF motor 15. The free rollers 18A are provided in a position that is in opposition to the carry roller 17A, and push the paper S toward the carry roller 17A by sandwiching the paper S between them and the carry roller 17A.

The paper discharge rollers 17B are rollers for discharging the paper S for which printing has finished to outside the printer. The paper discharge rollers 17B are driven by the PF motor 15 through a gear wheel that is not shown in the figure. The free rollers 18 are provided in a position that is in opposition to the paper discharge rollers 17B, and push the paper S toward the paper discharge rollers 17B by sandwiching the paper S between them and the paper discharge rollers 17B.

The ink ejection unit 20 is for ejecting ink onto paper, which is an example of the medium to be printed. The ink ejection unit 20 has a head 21 and a head driver 22. The head 21 has a plurality of nozzles, which are ink ejection sections, and ejects ink intermittently from each of the nozzles. The head driver 22 is for driving the head 21 so that ink is ejected intermittently from the head.

The cleaning unit 30 is for keeping the nozzles of the head 21 from becoming clogged. The cleaning unit 30 has a pump device 31 and a capping device 35. The pump device is for extracting ink from the nozzles in order to prevent the nozzles of the head 21 from becoming clogged, and has a pump motor 32 and a pump motor driver 33. The pump motor 32 sucks out ink from the nozzles of the head 21. The pump motor driver 33 drives the pump motor 32. The capping device 35 is for sealing the nozzles of the head 21 when printing is not being performed (during standby) so that the nozzles of the head 21 are kept from clogging.

The carriage unit 40 is for making the head 21 scan and move in a predetermined direction (in FIG. 1, the left and right directions of the paper face (hereinafter, this is referred to as the scanning direction)). The carriage unit 40 has a carriage 41, a carriage motor (hereinafter, referred to as CR motor) 42, a carriage motor driver (hereinafter, referred to as CR motor driver) 43, a pulley 44, a timing belt 45, and a guide rail 46. The carriage 41 can be moved in the scanning direction, and the head 21 is fastened to it (thus, the nozzles of the head 21 intermittently eject ink as they are moved in the scanning direction). The carriage 41 also removably holds an ink cartridge 48 that accommodates ink. The CR motor 42 is a motor for moving the carriage in the scanning direction, and is constituted by a DC motor. The CR motor driver 43 is for driving the CR motor 42. The pulley 44 is attached to a rotating shaft of the CR motor 42. The timing belt 45 is driven by the pulley 44. The guide rail 46 is for guiding the carriage 41 in the scanning direction.

The measuring instrument group 50 includes a linear encoder 51, a rotary encoder 52, a paper detection sensor 53, and a paper width sensor 54. The linear encoder 51 is for detecting the position of the carriage 41. The rotary encoder 52 is for detecting the amount of rotation of the carry roller 17A. It should be noted that the configuration, for example, of the encoders is discussed later. The paper detection sensor 53 is for detecting the position of the front end of the paper to be printed. The paper detection sensor 53 is provided in a position where it can detect the position of the front end of the paper as the paper is being carried toward the carry roller 17A by the paper supply roller 13. It should be noted that the paper detection sensor 53 is a mechanical sensor that detects the front end of the paper through a mechanical mechanism. More specifically, the paper detection sensor 53 has a lever that can be rotated in the paper carrying direction, and this lever is arranged so that it protrudes into the path over which the paper is carried. In this way, the front end of the paper comes into contact with the lever and the lever is rotated, and thus the paper detection sensor 53 detects the position of the front end of the paper by detecting the movement of the lever. The paper width sensor 54 is attached to the carriage 41. The paper width sensor 54 is an optical sensor having a light-emitting section 541 and a light-receiving section 543, and detects whether the paper exists or not in the position of the paper width sensor 54 by detecting light that is reflected by the paper The paper width sensor 54 detects the position of the edge of the paper while being moved by the carriage 41, so as to detect the width of the paper. The paper width sensor 54 can also detect the front end of the paper by the position of the carriage 41. The paper width sensor 54 is an optical sensor, and thus detects positions with higher precision than the paper detection sensor 53.

The control unit 60 is for carrying out control of the printer. The control unit 60 has a CPU 61, a timer 62, an interface section 63, an ASIC 64, a memory 65, and a DC controller 66. The CPU 61 is for carrying out the overall control of the printer, and sends control commands to the DC controller 66, the PF motor driver 16, the CR motor driver 43, the pump motor driver 32, and the head driver 22. The timer 62 periodically generates interrupt signals for the CPU 61. The interface section 63 exchanges data with a host computer 67 provided outside the printer. The ASIC 64 controls the printing resolution and the drive waveforms of the head, for example, based on printing information sent from the host computer 67 through the interface section 63. The memory 65 is for reserving an area for storing the programs for the ASIC 64 and the CPU 61 and a working area, for instance, and has storage means such as a RAM or an EEPROM. The DC controller 66 controls the PF motor driver 16 and the CR motor driver 43 based on control commands sent from the CPU 61 and the output from the measuring instrument group 50.

<Regarding the Configuration of the Encoders>

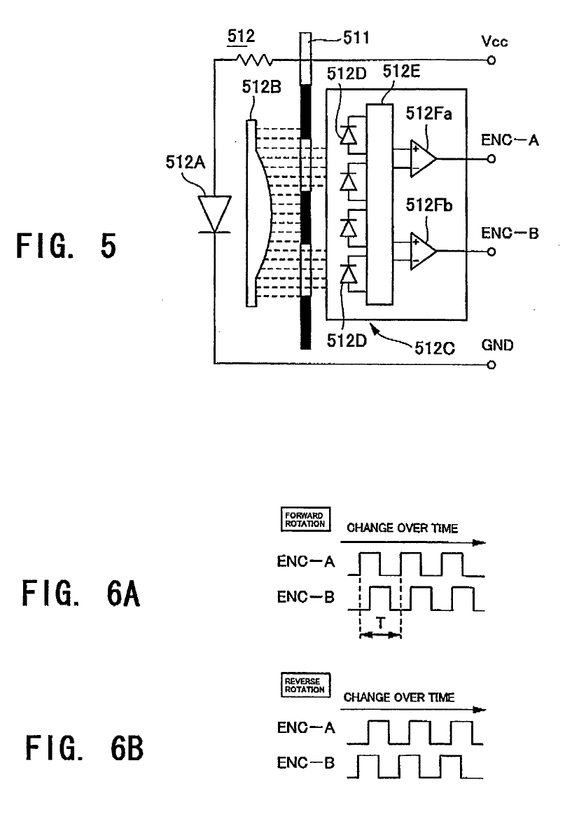

FIG. 5 is an explanatory diagram of the linear encoder 51.

The linear encoder 51 is for detecting the position of the carriage 41, and has a linear scale 511 and a detection section 512.

The linear scale 511 is provided with slits at a predetermined spacing (for example, every 1/180 inch (1 inch equals 2.54 cm)), and is provided on the main printer unit.

The detection section 512 is provided in opposition to the linear scale 511, and is on the carriage 41 side. The detection section 512 has a light-emitting diode 512A, a collimating lens 512B, and a detection processing section 512C. The detection processing section. 512C is provided with a plurality of (for instance, four) photodiodes 512D, a signal processing circuit 512E, and two comparators 512Fa and 512Fb.

The light-emitting diode 512A emits light when a voltage Vcc is applied to it via resistors on both sides, and this light is incident on the collimating lens. The collimating lens 512B turns the light that is emitted from the light-emitting diode 512A into parallel light, and irradiates the parallel light on the linear scale 511. The parallel light that passes through the slits provided in the linear scale then passes through stationary slits (not shown) and is incident on the photodiodes 512D. The photodiodes 512D convert the incident light into electrical signals. The electrical signals that are output from the photodiodes are compared in the comparators 512Fa and 512Fb, and the results of these comparisons are output as pulses. Then, the pulse ENC-A and the pulse ENC-B that are output from the comparators 512Fa and 512Fb become the output of the linear encoder 51.

FIG. 6 is a timing chart showing the waveforms of the two types of output signals of the linear encoder 51. FIG. 6A is a timing chart of the waveform of the output signal of the linear encoder 51 when the CR motor 42 is rotating forwards FIG. 6B is a timing chart of the waveform of the output signal of the linear encoder 51 when the CR motor 42 is rotating in reverse.

As shown in FIG. 6A and FIG. 6B, the phases of the pulse ENC-A and the pulse ENC-B are misaligned by 90 degrees both when the CR motor 42 is rotating forward and when it is rotating in reverse. When the CR motor 42 is rotating forward, that is, when the carriage 41 is moving in the main-scanning direction, then, as shown in FIG. 6A, the phase of the pulse ENC-A leads the phase of the pulse ENC-B by 90 degrees. On the other hand, when the CR motor 42 is rotating in reverse, then, as shown in FIG. 6B, the phase of the pulse ENC-A is delayed by 90 degrees with respect to the phase of the pulse ENC-B. A single period T of the pulses is equivalent to the time during which the carriage 41 is moved by the spacing of the slits of the linear scale 511 (for example, by 1/180 inch (1 inch equals 2.54 cm)).

The position of the carriage 41 is detected as follows. First, the rising edge or the falling edge of either the pulse ENC-A or ENC-B is detected, and the number of detected edges is counted. The position of the carriage 41 is calculated based on the counted number. With respect to the counted number, when the CR motor 42 is rotating forward a “+1” is added for each detected edge, and when the CR motor 42 is rotating in reverse a “−1” is added for each detected edge. Since the period of the pulses ENC is equal to the slit spacing of the linear scale 511, when the counted number is multiplied by the slit spacing, the amount that the carriage 41 has moved from when the count number is “0” can be obtained. In other words, the resolution of the linear encoder 51 in this case is the slit spacing of the linear scale 511. It is also possible to detect the position of the carriage 41 using both the pulse ENC-A and the pulse ENC-B. The periods of the pulse ENC-A and the pulse ENC-B are equal to the slit spacing of the linear scale 511, and the phases of the pulses ENC-A and ENC-B are misaligned by 90 degrees, so that if the rising edges and the falling edges of the pulses are detected and the number of detected edges is counted, then a counted number of “1” corresponds to ¼ of the slit spacing of the linear scale 511. Therefore, if the counted number is multiplied by ¼ of the slit spacing, then the amount that the carriage 41 has moved from when the count number was 1″0 can be obtained. That is, the resolution of the linear encoder 51 in this case is ¼ the slit spacing of the linear scale 511.

The velocity Vc of the carriage 41 is detected as follows. First, the rising edges or the falling edges of either the pulse ENC-A or ENC-B are detected. The time interval between edges of the pulses is counted with a timer counter. The period T (T=T1, T2, . . . ) is obtained from the value that is counted. Then, when the slit spacing of the linear scale 511 is regarded as λ, the velocity of the carriage can be sequentially obtained as %/T. It is also possible to detect the velocity of the carriage 41 using both the pulse ENC-A and the pulse ENC-B. By detecting the rising edges and the falling edges of the pulses, the time interval between edges, which corresponds to ¼ of the slit spacing of the linear scale 511, is counted by the timer counter. The period T (T=T1, T2, . . . ) is obtained from the value that is counted. Then, if the slit spacing of the linear scale 511 is regarded as λ, the velocity Vc of the carriage can be found sequentially as Vc=λ/(4T).

It should be noted that the rotary encoder 52 has substantially the same configuration as the linear encoder 51, except that a rotation disk 521 that rotates in conjunction with rotation of the carry roller 17A is used in place of the linear scale 511 provided on the main printer unit, and that a detection section 522 provided on the main printer unit is used in place of the detection section 512 that is provided on the carriage 41 (see FIG. 4).

It should be noted that the rotary encoder 52 directly detects the rotation amount of the carry roller 17A, and does not detect the carry amount of the paper. However, when the carry roller 17A is rotated to carry the paper, a carry error occurs due to slippage between the carry roller 17A and the paper. Consequently, the rotary encoder 52 cannot directly detect the carry error of the carry amount of the paper. Accordingly, a table that expresses the relationship between the rotation amount detected by the rotary encoder 52 and the carry error is created and stored in the memory 65 of the control unit 60. Then, the table is referenced based on the results of the detection of the rotary encoder, and the carry error is detected. This table is not limited to expressing the relationship between the rotation amount and the carry error, and may also be a table that expresses the relationship between the number of times of carries, for example, and the carry error. Also, because slippage differs depending on the characteristics of the paper, it is also possible to create a plurality of tables corresponding to the paper characteristics and to store these in the memory 65.

<Configuration of the Nozzles>

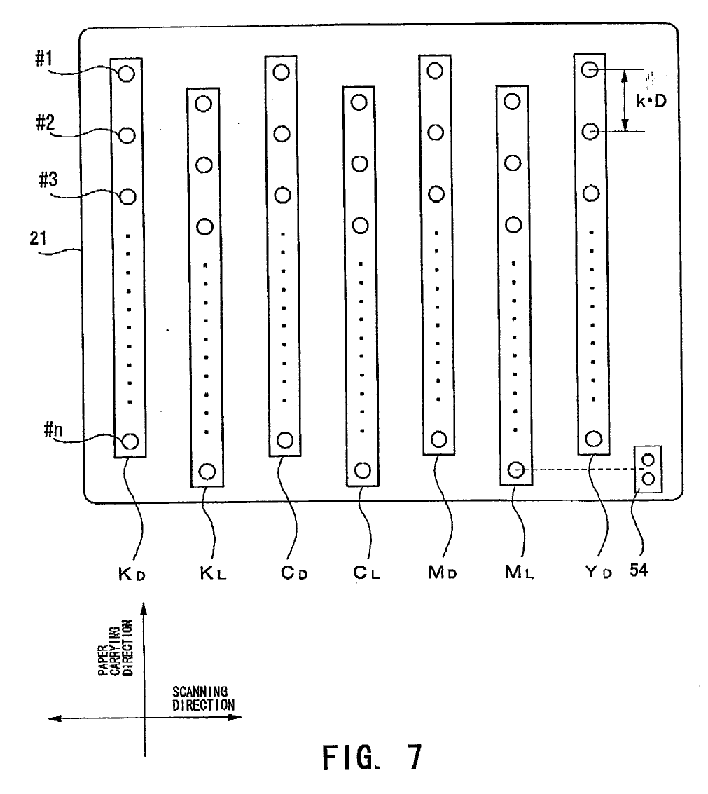

FIG. 7 is an explanatory diagram showing the arrangement of the nozzles in the lower surface of the head 21. In the lower surface of the head 21 there are formed a dark black ink nozzle group KD, a light black ink nozzle group KL, a dark cyan ink nozzle group CD, a light cyan ink nozzle group CL, a dark magenta ink nozzle group MD, a light magenta nozzle group ML, and a yellow ink nozzle group YD. Each nozzle group is provided with a plurality (in this embodiment, n) of nozzles, which are ejection openings for ejecting the various colors of ink. It should be noted that the first alphabet letter in the reference characters indicating the nozzle groups represents the ink color, whereas the accompanying letter “D” means that the ink is of relatively high concentration and the accompanying letter “L” means that the ink is of relatively low concentration.

The plurality of nozzles of the nozzle groups are arranged at a constant spacing (nozzle pitch: k·D) in the paper carrying direction. Here, D is the minimum dot pitch in the paper carrying direction (that is, the spacing at the highest resolution of the dots formed on the paper S). Also, k is an integer of 1 or more.

The nozzles of the nozzle groups are assigned numbers that become smaller toward the downstream side (#1 to #n). Also, as regards their positions in the paper carrying direction, the nozzles of each nozzle group are provided so that they are positioned between the nozzles of adjacent nozzle groups. For example, the first nozzle #1 of the light black ink nozzle group KL is provided between the first nozzle #1 and the second nozzle #2 of the dark black ink nozzle group KD, as regards its position in the paper carrying direction. Also, the paper width sensor 54 is provided substantially in the same position as the nth nozzle #n furthest downstream, as regards its position in the paper carrying direction. Each nozzle is provided with a piezo element (not shown) as a drive element for driving each nozzle and making it eject ink droplets.

It should be noted that during printing, the paper S is carried intermittently by the paper carrying unit 10 by a predetermined carry amount, and between these intermittent carries the carriage 41 is moved in the main-scanning direction and ink droplets are ejected from the nozzles.

===Configuration of the Platen===

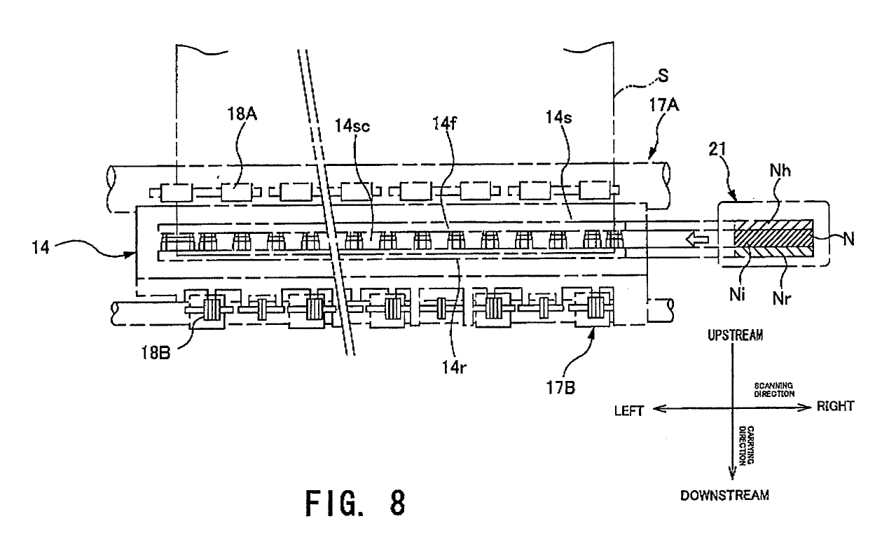

FIG. 8 is an explanatory diagram showing the positional relationship between the grooves provided in the platen and the nozzle groups. Previously described structural components are assigned identical reference numbers in the diagram, and description thereof is omitted.

The platen 14 has recessed sections and protruding sections. For the recessed sections, the platen 14 has two grooves formed in the scanning direction. Of these two grooves, the groove on the upstream side is referred to as the upstream side groove 14f and the groove on the downstream side is referred to as the downstream side groove 14r. These grooves are formed in the platen 14 such that in the scanning direction they are longer than the width of the paper S. These grooves are also provided with an absorptive body for absorbing ink.

Also, as the protruding sections, the platen 14 has a central support section 14sc. This support section supports the paper S in such a manner that it is in opposition to the head 21. The central support section 14sc supports the paper S between the upstream side groove 14f and the downstream side groove 14r.

The various color nozzle groups of the head 21 each have an upstream side supra-groove nozzle group Nh, a central nozzle group Ni, and a downstream side supra-groove nozzle group Nr. The upstream side supra-groove nozzle group Nh is a nozzle group provided in a position that opposes the upstream side groove 14f, and is constituted by the nozzles #131 to #180. The central nozzle group Ni is a nozzle group provided in position that opposes the central support section 14sc, and is constituted by the nozzles #26 to #130. The downstream side supra-groove nozzle group Nr is a nozzle group provided in a position that opposes the downstream side groove 14r, and is constituted by the nozzles #1 to #25. It should be noted that in the diagram each nozzle group is provided in the region shown by the oblique line.

By moving the carriage 41 in the scanning direction, the head 21 is also moved in the scanning direction. Since the upstream side groove 14f and the downstream side groove 14r are formed in the scanning direction, it is possible for the nozzle group Nh to remain in opposition to the upstream side groove 14f while moving and for the nozzle group Nr to remain in opposition to the downstream side groove 14r while moving. Even if ink were ejected from the nozzle group Nh without there being a paper S, the ink that is ejected would still land in the upstream side groove 14f, and thus the support section of the platen would not become dirty, so that later the rear surface of the paper that is carried would not become dirty. Likewise, even if ink were ejected from the nozzle group Nr without there being a paper S on the platen, the ink that is ejected would still land in the downstream side groove 14r, and thus the support section of the platen would not become dirty, so that later the rear surface of the paper that is carried would not become dirty. Moreover, since an ink absorptive body is provided in each of these grooves, the ink absorptive bodies absorb the ink that lands in the grooves.

It should be noted that, as will become clear from the following description, the reason that the platen has the above configuration is so that the support section of the platen is not dirtied by ink that is ejected when printing the front end of the paper (when performing so-called borderless printing).

===Method for Printing the Front End of the Paper===

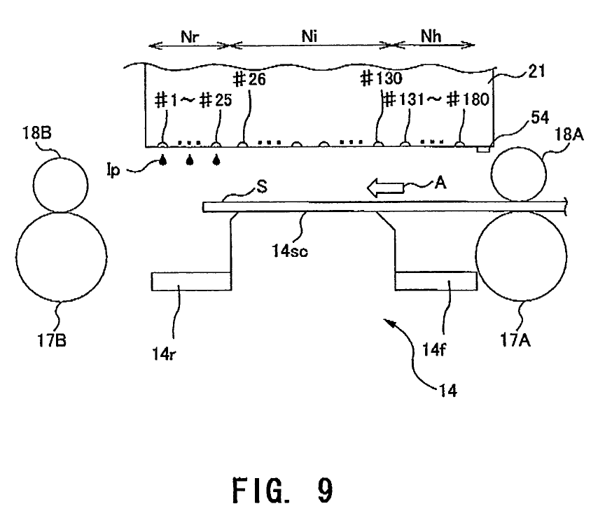

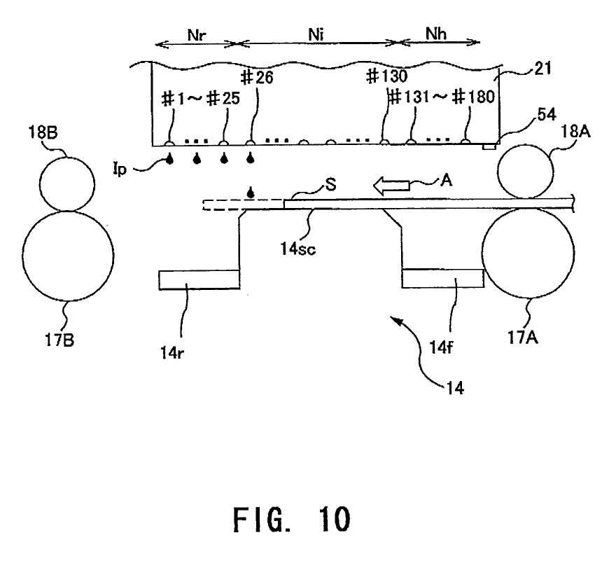

FIG. 9 is an explanatory diagram showing a method for printing the front end of the paper (a method for borderless printing).

First, the paper width sensor 54 downstream of the carry roller 17A is used to detect the front end of the paper, and based on the results of this detection, the paper S is carried.

Then, the paper is carried based on the results of the detection by the paper width sensor 54, and the front end of the paper is positioned at the print start position (this positioning operation is the so-called print start positioning operation). It should be noted that with the printing method of this embodiment, the paper is carried based on the results of the detection of the paper width sensor 54, and thus the front end of the paper can be positioned more accurately than if the paper is carried based on the results of the detection by the paper detection sensor 53.

Then, the paper S is carried intermittently by a carry amount that corresponds to the print mode and ink is ejected from only the nozzle group Nr between these intermittent carries, printing the front end of the paper.

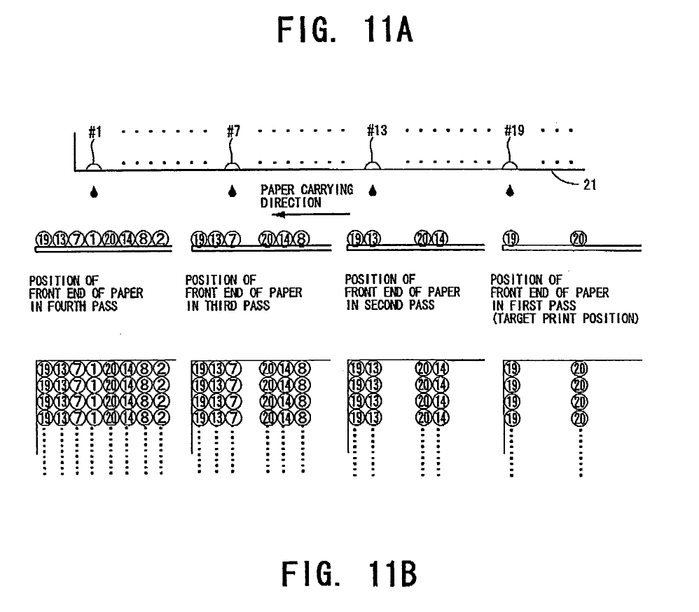

The reason why only the nozzle group Nr is used when printing the front end of the paper is that carry error causes the front end of the paper S to be positioned above the central support portion 14sc of the platen 14 when the print start positioning operation is finished (see FIG. 10). That is, when the nozzle group Ni is used in this case, the ink droplets Ip land on the central support portion 14sc of the platen, and thus the support portion of the platen becomes dirty. On the other hand, even in this case, if only the nozzle group Nr is used then the ink droplets Ip land in the downstream side groove 14r, and thus the support portion of the platen is kept from becoming dirty.

However, if the paper can be carried with less carry error, then the front end of the paper can be accurately positioned above the downstream side groove 14r and printing can be carried out using all the nozzles. If the front end of the paper is positioned above the downstream side groove 14r when printing is started, then the ink that is ejected lands on the paper even if the nozzle group Ni or the nozzle group Nh is used, and thus the platen does not become dirty. In this case, a target print start position is set so that the front end of the paper is positioned between the downstream side groove 14r, which is a recessed portion, and the nozzles in opposition to the downstream side groove 14r.

It should be noted that in the embodiment described below, the front end of the paper is printed using only the nozzle group Nr (nozzles #1 to #25).

===Print Start Position===

Next, methods of carrying according to various print modes in a case where each nozzle group has 180 nozzles and the nozzle pitch (spacing between nozzles) is 1/180 inch are described. However, when printing the front end of the paper, only the nozzle group Nr (nozzles #1 to #25) is used, as described above. The positional relationship between the grooves and the nozzle groups is the same as that described above. Here, for the sake of simplifying the description, a print mode for a nozzle group of a particular color is described, but the same applies for nozzle groups of other colors as well.

<Interlace Printing in Four Passes>

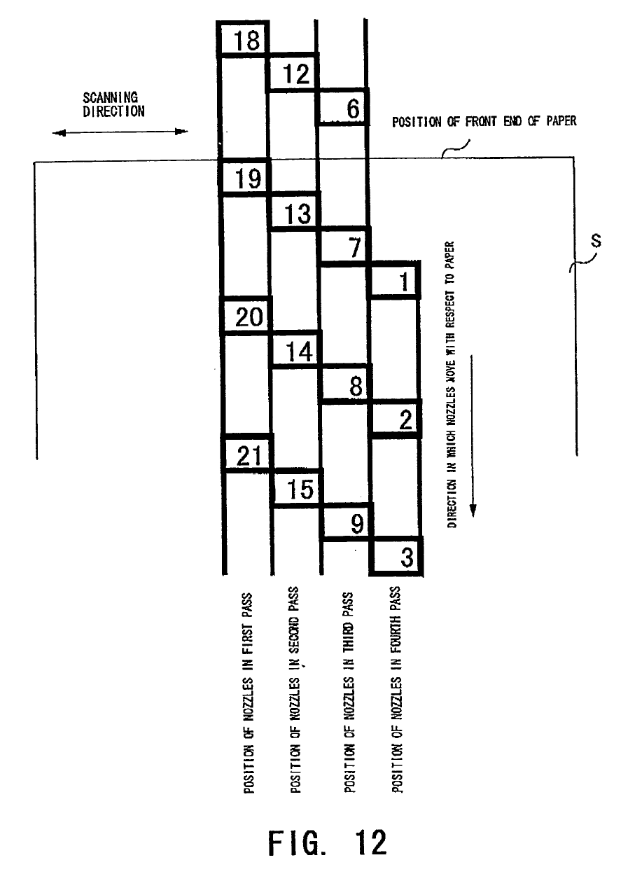

First, using FIG. 11 and FIG. 12, a case where interlace printing is carried out in four passes is described. Bere, “interlace printing” is used to refer to a print mode in which k is at least 2 (in this embodiment, k=4) and a raster line that is not recorded is sandwiched between raster lines that are recorded in a single pass. It should be noted that “pass” refers to a single scan in which the nozzles are moved in the scanning direction. Also, “raster lines” are the rows (dot rows) of pixels lined up in the scanning direction, and are also known as scan lines. “Pixels” are the square grids that are determined in a virtual manner on the medium to be printed in order to define the positions where ink droplets are made to land so as to record dots. In this embodiment, four raster lines are printed per nozzle pitch, and thus interlace printing is carried out at 720 dpi resolution. It should be noted that with interlace printing there is the effect that even if there is variation in the pitch or ejection characteristics of the nozzles, the impact of these can be lessened to improve the picture quality. Also, with interlace printing, since the paper S is carried by a carry amount (in this print mode, 25·D or 179·D) that is larger that the spacing D between the dot rows, the carry amount is larger than when carrying is carried out at the spacing D between the dot rows, and thus the carrying precision can be increased, improving the picture quality.

FIG. 11 is an explanatory diagram showing the relationship between the position of the front end of the paper and the position of the nozzles. FIG. 11A is a view of the carrying direction from the side, in which the direction perpendicular to the paper plane is the scanning direction. FIG. 11B is a view of the carrying direction from above, in which the top to bottom direction of the paper plane is the scanning direction. The diagram shows how ink is ejected from the nozzles of the nozzle group Nr of the head 21 to form dots on the surface of the paper S. The numbers in the circles drawn on the surface of the paper S denote the number of the nozzle ejecting the ink droplets forming that particular dot. It should be noted that the paper S, as shown in the drawing, is carried intermittently in the paper carrying direction. Then, between these intermittent carries, the head 21 is scanned and moved in the scanning direction (direction perpendicular to the paper plane) and ink is ejected from the nozzles.

FIG. 12 is an explanatory diagram showing the relative positional relationship between the position of the front end of the paper and the position of the nozzles in the print mode of FIG. 11. This diagram shows the relative positional relationship between the position of the paper and the position of the nozzles with the paper being fixed. When shown in this way, the nozzles move in the carrying direction with respect to the paper S and eject ink while moving in the scanning direction, forming dots on the paper S.

With this print mode, first, a target print position is determined such that the front end of the paper is positioned at the nozzle #19, and the paper S is carried. Then, in a first pass, ink is ejected from nozzles #19 to #25 to form dot rows on the paper S in the scanning direction. Next, the paper S is carried by a carry amount equal to 25 raster lines, and then in a second pass, ink is ejected by nozzles #13 to #25 to form dot rows on the paper S. Next, the paper S is carried by a carry amount that is equal to 25 raster lines (25/720 inch), and then in a third pass, ink is ejected by nozzles #7 to #25 to form dot rows on the paper S. Next, the paper S is carried by a carry amount that is equal to 25 raster lines, and in a fourth pass, ink is ejected from nozzles #1 to #25 to form dot rows on the paper S. Then, in the same manner hereinafter as well, printing is carried out with respect to the paper S by repeating the intermittent carry operation and the printing operation in alternation.

According to this print mode, the initial position of the front end of the paper S is the position in opposition to the nozzle #19. Then, the nozzle #19 ejects ink droplets corresponding to a first raster line. It should be noted that when the front end of the paper is positioned downstream of the nozzle #19, the paper. S is printed leaving a margin portion at the front end of the paper. However, if the front end of the paper is positioned upstream of the nozzle #19, then the ink droplets that are ejected from the nozzle land only in the groove, and therefore the paper S can be printed without leaving a margin portion at the front end of the paper. Consequently, when there is carry error as the paper is carried, the target print position is set so that the position of the front end of the paper S when the paper S has been carried furthest downstream is in opposition to the nozzle #19 (or is upstream of the nozzle #19).

With the printing apparatus of this embodiment, the nozzles to use in the first pass (when recording of the front end is started) are determined according to the print mode. In the case of “interlace printing in four passes,” it is determined that nozzles #19 through #25 are used in the first pass. In this way, by determining which nozzles to use when starting printing according to the print mode, the ejection of unnecessary ink can be reduced. It should be noted that in other print modes described later as well, the printing apparatus of this embodiment determines the nozzles to be used when starting printing according to the print mode.

Also, the printing apparatus of this embodiment determines which nozzle ejects ink droplets corresponding to the first raster line according to the print mode. In the case of “interlace printing in four passes,” it is determined that the nozzle #19 ejects the ink droplets that correspond to the first raster line. In this way, by determining which nozzle ejects the ink droplets that correspond to the first raster line according to the print mode, the ejection of unnecessary ink can be reduced. It should be noted that in other print modes described later as well, the printing apparatus of this embodiment determines which nozzle ejects the ink droplets that correspond to the first raster line according to the print mode.

Incidentally, the carry amount in interlace printing is determined based on the nozzle pitch and the number of nozzles. When recording to the front end of the paper, the carry amount is determined to be 25·D based on the fact that the nozzle pitch is 4·D and the number of nozzles to be used is 25. On the other hand, if printing of the front end of the paper S has finished, then the number of nozzles that are used is 180, and therefore the carry amount is determined to be 179·D. However, when there is a sudden shift from front end printing (printing with a carry amount of 25·D using nozzles #1 to #25) to normal printing (printing with a carry amount of 179·D using nozzles #1 to #180), raster lines that are not printed will be created during this shift. Accordingly, in the present embodiment, when shifting from front end printing to normal printing, printing (shift printing) is performed at a carry amount of 25·D using nozzles #1 to #25 and the nozzles upstream of nozzle #25 (nozzles #26 and up). Thus, the raster lines can be printed without gaps.

<Overlap Printing in Eight Passes>

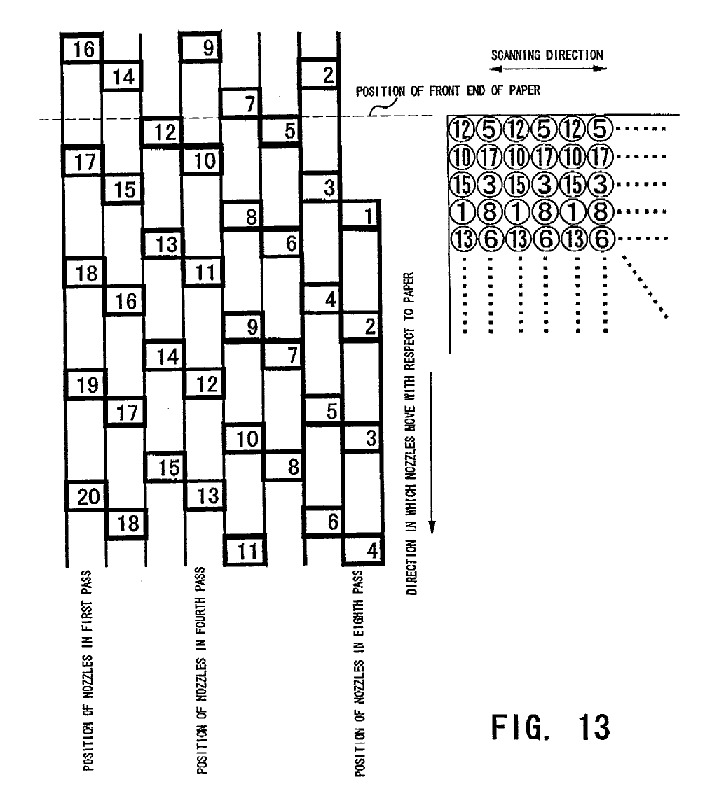

Next, using FIG. 13, a case in which overlap printing is performed in eight passes is described. The diagram on the left, like FIG. 12 discussed above, shows the relative positional relationship between the position of the front end of the paper and the position of the nozzles. The diagram on the right, like FIG. 11B discussed above, shows how dots are formed on the surface of the paper S. Here, “overlap printing” is a print mode in which the dot rows forming the raster lines are not recorded using only the same nozzle but rather are recorded using a plurality of nozzles. In this embodiment each raster line is formed using two nozzles, and since four raster lines are formed in the nozzle pitch, four raster lines are completed in eight passes. It should be noted that in this embodiment, since four raster lines are printed every nozzle pitch, printing is carried out at 720 dpi resolution. It should also be noted that with overlap printing, even if there is variation in the nozzle pitch or the ejection characteristics, the characteristics of a specific nozzle can be kept from affecting an entire raster line, and thus there is the effect that the picture quality can be increased.

With this print mode, first, the target print position is set so that the front end of the paper is positioned upstream of the nozzle #17 by an amount of one raster line, and the paper S is carried. Then, in a first pass, ink is ejected by nozzles #17 to #25, forming dot rows on the paper S in the scanning direction. However, at this time, the nozzles form dots leaving out every other dot. It should noted that the dot rows formed having every other dot missing are completed in the fourth pass by the nozzles #10 to #25 ejecting ink every other dot, thereby completing the second raster line. With this print mode, the paper S is carried intermittently by a carry amount that is equal to nine or ten raster lines (9·D (9/720 inch) or 10·D (10/720 inch)), and between these intermittent carries, dot rows are formed leaving out every other dot.

According to this print mode, the initial position of the front end of the paper S is upstream of the position in opposition to the nozzle #17 by an amount of one raster line. The nozzle #17 ejects ink droplets that correspond to the second raster line leaving out every other dot. It should be noted that when the front end of the paper is positioned downstream of this position, the paper S is printed leaving a margin portion at the front end of the paper. However, if the front end of the paper is positioned upstream of this position, then the ink droplets that are ejected from the nozzles land only in the groove, and therefore the paper S can be printed without leaving a margin portion at the front end of the paper. Consequently, when there is carry error during carrying of the paper, the target print position is determined in such a manner that the position of the front end of the paper S when the paper S has been carried furthest downstream is upstream of the position in opposition to nozzle #17 by an amount of one raster line (or is upstream of the nozzle #17).

With this print mode, the printing apparatus determines that the nozzles #17 through #25 are used in the first pass. Also, with this print mode, the printing apparatus determines that the nozzles #12 and #5 eject the ink droplets that correspond to the first raster line.

Also, in this embodiment, the carry amount during front end printing is 9·D (9/720 inch) or 10·D (10/720 inch), and the carry amount during normal printing is 89·D or 90·D. During the shift from front end printing to normal printing, printing (shift printing) is carried out at a carry amount of 9·D or 10·D using nozzles #1 to #25 and the nozzles upstream of nozzle #25 (nozzles #26 and up). Thus, raster lines are printed without there being gaps.

<Overlap Printing in 16 Passes>

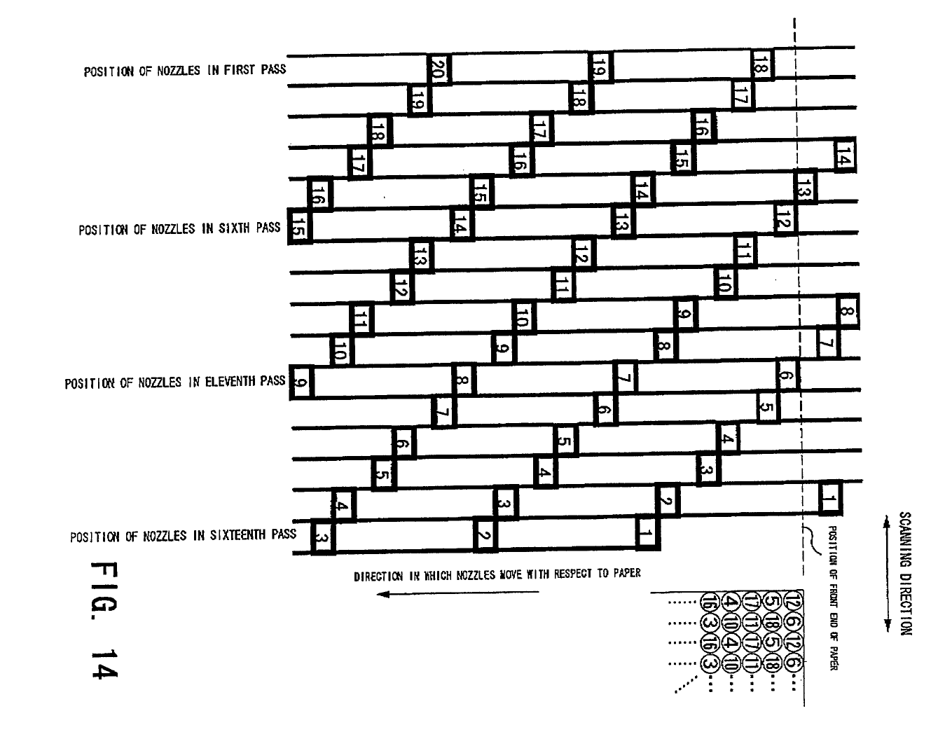

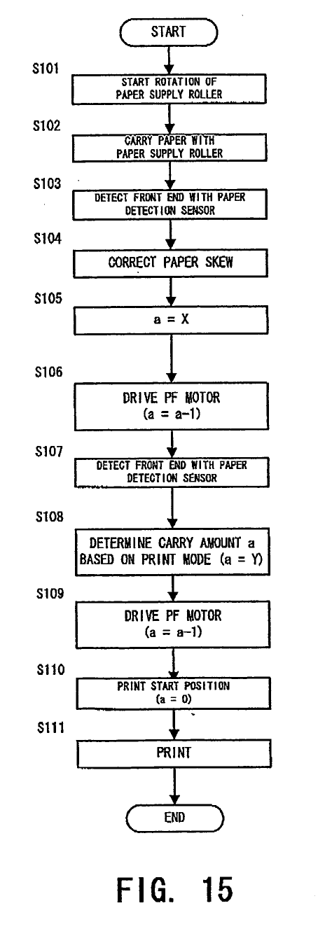

Next, using FIG. 14, a case in which overlap printing is performed in 16 passes is described. In this embodiment, each raster line is formed using two nozzles, and since eight raster lines are formed in the nozzle pitch, eight raster lines are completed in 16 passes. It should be noted that in this embodiment, since eight raster lines are printed every nozzle pitch, the printing resolution is 1440 dpi.

With this print mode, first, the target print position is determined so that the front end of the paper is positioned upstream of the nozzle #18 by an amount of one raster line, and the paper S is carried. Then, in a first pass, ink is ejected by nozzles #18 to #25 to form dot rows on the paper S in the scanning direction. However, at this time, the nozzles form dots leaving out every other dot. It should noted that the dot rows formed intermittently are completed in the twelfth pass by the nozzles #5 to #25 ejecting ink every other dot, thereby completing the second raster line. In this print mode, the paper S is carried intermittently by a carry amount that is equal to nine or ten raster lines (9·D (9/1440 inch) or 10·D (10/1440 inch)), and between those intermittent carries, dot rows are formed leaving out every other dot.

According to this print mode, the initial position of the front end of the paper S is upstream of the position in opposition to the nozzle #18 by an amount of one raster line. The nozzle #18 ejects ink droplets corresponding to the second raster line leaving out every other dot. It should be noted that when the front end of the paper is positioned downstream of this position, the paper S is printed leaving a margin portion at the front end of the paper. However, if the front end of the paper is positioned upstream of this position, then the ink droplets that are ejected from the nozzles land only in the groove, and therefore the paper S can be printed without leaving a margin portion at the front end of the paper. Consequently, when there is carry error during carrying of the paper, the target print position is determined in such a manner that the position of the front end of the paper S when the paper S has been carried furthest downstream is upstream of the position in opposition to nozzle #18 by an amount of one raster line (or is upstream of the nozzle #18).

In this print mode, the printing apparatus determines that the nozzles #18 through #25 are used in the first pass. Also, in this print mode the printing apparatus also determines that the nozzles #12 and #6 eject the ink droplets that correspond to the first raster line.

Also, in this embodiment, the carry amount during front end printing is 9·D (9/1440 inch) or 10·D (10/1440 inch), and the carry amount during normal printing is 89·D or 90·D. During the shift from front end printing to normal printing, printing (shift printing) is carried out at a carry amount of 9·D or 10−D using nozzles #1 to #25 and the nozzles upstream of nozzle #25 (nozzle #26 and up). Thus, raster lines are printed without there being gaps.

===Paper Carry Sequence===

As can be understood from the above description, the position of the front end of the paper in the first pass can be changed according to the print mode. That is, according to the print mode, the paper can be carried up to a position that is appropriate for that print mode. Accordingly, in this embodiment, the paper is carried as illustrated below.

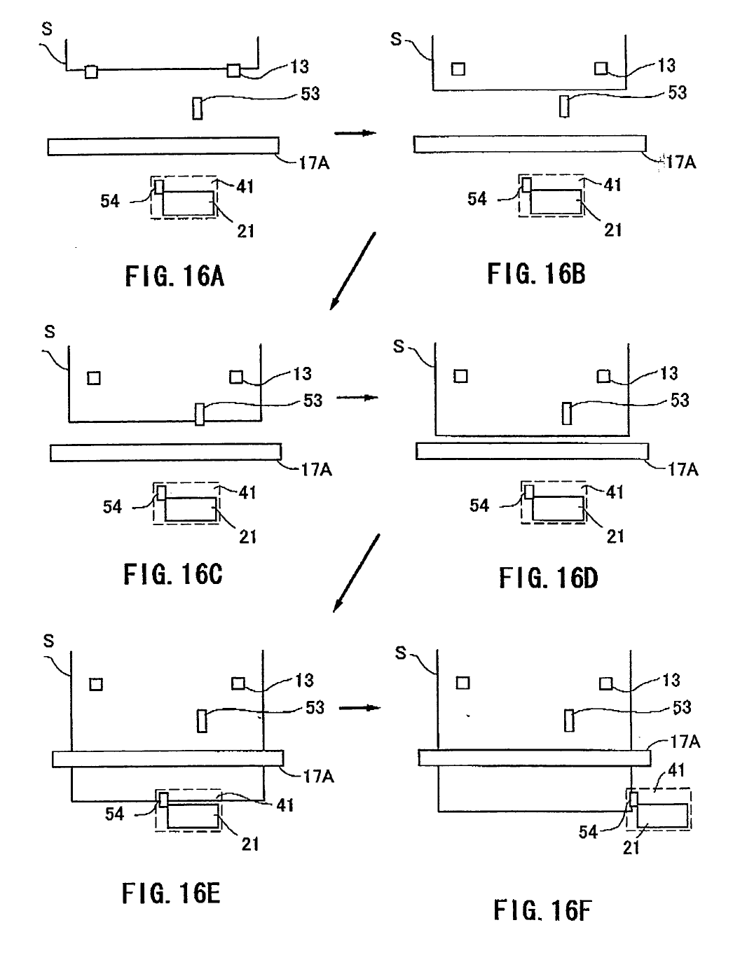

FIG. 15 is a flowchart showing the sequence in which the paper is carried. It should be noted that this sequence is executed by the control unit 60. Also, FIG. 16 is a diagram showing the positional relationship between the paper and the various structural elements when the paper is carried up to the print start position. It should be noted that FIG. 16 is a diagram in which the structural elements are viewed from above, and the direction toward the bottom of the paper plane is the paper carrying direction. The structural elements are assigned the same reference numerals as those used in the foregoing description, and thus description of the structural elements is omitted.

First, rotation of the paper supply roller 13 starts when a print command is given to the printer (S101). The initial position of the paper S is as shown in FIG. 16A. It should be noted that a plurality of the paper S are kept from being supplied at one time by the rotational drive force of the paper supply roller 13 and the friction resistance of the separating pads (not shown).

Next, the paper S is carried in the paper carrying direction by the paper supply roller 13 (S102). The position of the paper S at this time is as shown in FIG. 16B. It should be noted that the peripheral length of the circumference section of the paper supply roller 13 is set longer than the carrying distance to the carry roller 17A, so that using this circumference section the medium to be printed can be carried up to the carry roller 17A.

Next, the position of the front end of the paper S is detected by the paper detection sensor 53 (S103). That is, it can be detected that the front end of the paper S has arrived at the position of the paper detection sensor 53 by detecting the rotation of the lever of the paper detection sensor 53 when the front end of the paper S comes into contact with the lever. The position of the paper S at this time is as shown in FIG. 16C.

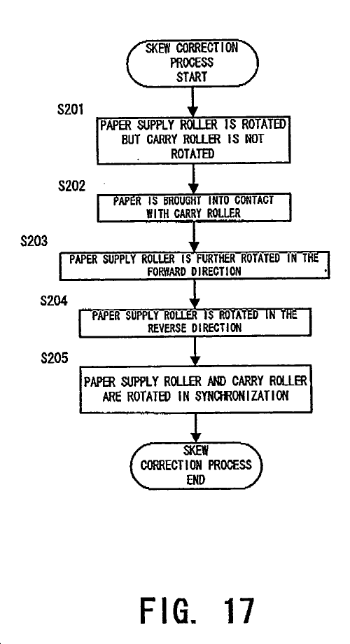

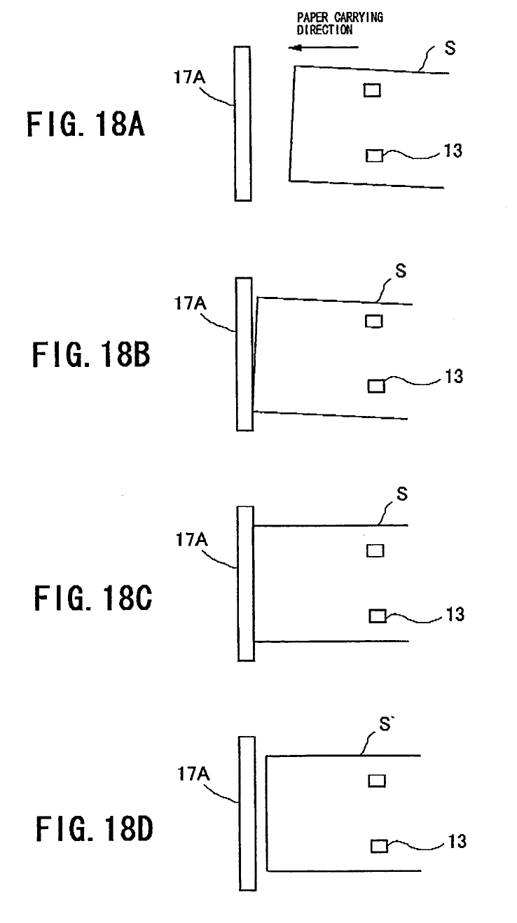

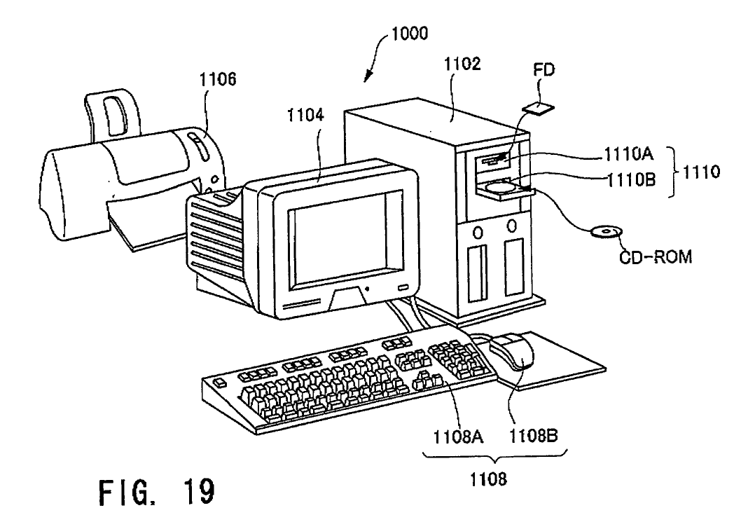

Next, skew in the paper is corrected (S104). The process for correcting paper skew is described using FIG. 17 and FIG. 18. It should be noted that FIG. 17 is a flowchart for correction of paper skew, and FIG. 18 is a diagram seen from above showing how paper skew is corrected. First, in a state where the rotation of the carry roller 17A is stopped, the paper supply roller 13 is rotated in the forward direction (the rotation direction in which the paper is carried in the paper carrying direction), carrying the paper S in the paper carrying direction (S201, FIG. 1A). Next, the paper S is brought into contact with the carry roller 17A (S202, FIG. 18B). Then, the paper supply roller 13 is further moved in the forward direction by a predetermined amount (S203). At this time, the paper S is not carried because the carry roller 17A is stopped, and thus slippage occurs between the paper supply roller 13 and the paper S, making the front end of the paper S parallel to the carry roller 17A (FIG. 18C). Next, the paper supply roller 13 is rotated in reverse, separating the paper S from the carry roller 17A (S204, FIG. 18D). Then, rotation of the carry roller 17A is started in order to carry the paper S. At this time, the paper supply roller 13 and the carry roller 17A are rotated in synchronization with one another so that the amount the paper is carried by the paper supply roller 13 and the amount the paper is carried by the carry roller 17A are the same (S205). By performing the above process, skew in the paper can be corrected before the paper is carried, It should be noted that the amount that the paper supply roller 13 is rotated in the above process for correcting paper skew is controlled based on the position of the front end of the paper that is detected by the paper detection sensor 53.

Next, in order to adjust the settings so that the paper S is carried from the state shown in FIG. 16D (FIG. 18D) up to a predetermined paper carry amount X, the value of the counter, which is not shown, is set to X (S105), the PF motor 15 is rotated to reduce the value of the counter based on the pulse signal from the rotary encoder 52 (S106), and the PF motor 15 is driven until it has carried the paper up to the predetermined paper carry amount X.

When the front end of the paper S is detected by the paper width sensor 54 as the paper S is being carried up to the paper carry amount X (FIG. 16E)(S107), the setting for the remaining paper carry amount is changed and the value of the counter is set so that the paper S is carried up to a predetermined paper carry amount Y (S108). In other words, the setting for the carry amount that was set based on the results of the detection by the paper detection sensor 53 is changed based on the results of the detection by the paper width sensor 54. Then, the PF motor 15 is rotated to reduce the value of the counter based on the pulse signal from the rotary encoder 52 (S109), and the PF motor 15 is driven until the paper has been carried by the paper carry amount Y (S110, FIG. 16F). It should be noted that in FIG. 16F, the location of the carriage 41 is moved so that the edge of the paper is detected by the paper width sensor 54.

The position of the paper S when the paper S has finished being carried by the paper carry amount Y (when the counter is a=0) as described above is the “print start position.” Here, the “print start position” is the position of the paper when printing is started. After the paper has been carried to the print start position, the first pass of the printing is started (S111). It should be noted that, as described above, the nozzles used when printing the first pass are determined according to the print mode. Also, the nozzle that ejects the ink droplets that correspond to the first raster line is also determined according to the print mode.

The position of the paper when printing is started is determined by the print mode. That is, in an “interlace print mode of 720 dpi,” for example, the print start position is the position in which the front end of the paper is in opposition to the nozzle #19 (or a position upstream of this position). Then, the paper carry amount Y is set as the target print start position so that the paper is positioned at the print start position.

The memory 65 of the control unit 60 stores a table correlating the print mode and the paper carry amount Y. When printing is performed, the control unit 60 determines the print mode based on a print command received by the printer and references the table stored in the memory 65 so as to determine the paper carry amount corresponding to the print mode. Thus, the paper carry amount Y is determined based on the print mode.

In this embodiment, the paper can be carried to a print start position that is suited for the print mode, and thus unnecessary paper carry operations are reduced and the printing speed can be increased, allowing the print time to be shortened.

Also, in this embodiment, the front end of the paper S is detected by the paper width sensor 0.54 and the paper carry amount is set based on the results of the detection by the paper width sensor 54. That is, in this embodiment the paper S is carried based on the results of the detection by the paper width sensor 54. Consequently, in this embodiment the paper S is carried up to the printing position with high positional accuracy.

Also, in this embodiment, the paper width sensor 54 is provided more downstream than the carry roller. Thus, even if the paper S slips when it comes into contact with the carry roller, the front end of the paper S is detected after it has slipped, and thus if the paper S is carried based on the results of this detection, it can be carried with high positional accuracy.

Also, in this embodiment, the front end of the paper is detected by the paper width sensor 54 after paper skew has been corrected. Thus, the position of the front end of the paper is detected accurately, so that if the paper S is carried based on the results of the detection by the paper width sensor, the paper S is carried with high positional accuracy.

===Configuration of the Computer System etc.===

Next, an embodiment of a computer system, a computer program, and a storage medium on which the computer program is recorded are described with reference to the figure.

FIG. 19 is an explanatory drawing showing the external structure of the computer system. A computer system 1000 is provided with a main computer unit 1102, a display device 1104, a printer 1106, an input device 1108, and a reading device 1110. In this embodiment, the main computer unit 1102 is accommodated within a mini-tower type housing; however, this is not a limitation. A CRT (cathode ray tube), plasma display, or liquid crystal display device, for example, is generally used as the display device 1104, but this is not a limitation. The printer 1106 is the printer described above. In this embodiment, the input device 1108 is a keyboard 1108A and a mouse 1108B, but it is not limited to these. In this embodiment, a flexible disk drive device 1110A and a CD-ROM drive device 1110B are used as the reading device 1110, but the reading device 1110 is not limited to these, and it may also be an MO (magnet optical) disk drive device or a DVD (digital versatile disk), for example.

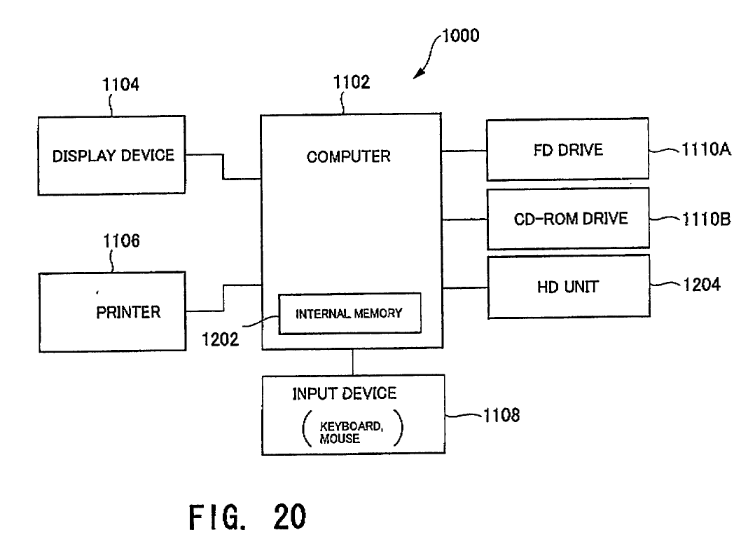

FIG. 20 is a block diagram showing the configuration of the computer system shown in FIG. 19. An internal memory 1202 such as a RAM within the housing accommodating the main computer unit 1102 and, also, an external memory such as a hard disk drive unit 1204 are provided.

A computer program for controlling the operation of the above printer can be downloaded onto the computer system 1000, for example, connected to the printer 1106 via a communications line such as the Internet, and it can also be recorded onto a computer-readable storage medium and distributed, for example. Various types of storage media can be used as this storage medium, including flexible disks FDS, CD-ROMs, DVD-ROMs, magneto optical disks MOs, hard disks, and memories. It should be noted that information stored on such storage media can be read by various types of reading devices 1110.

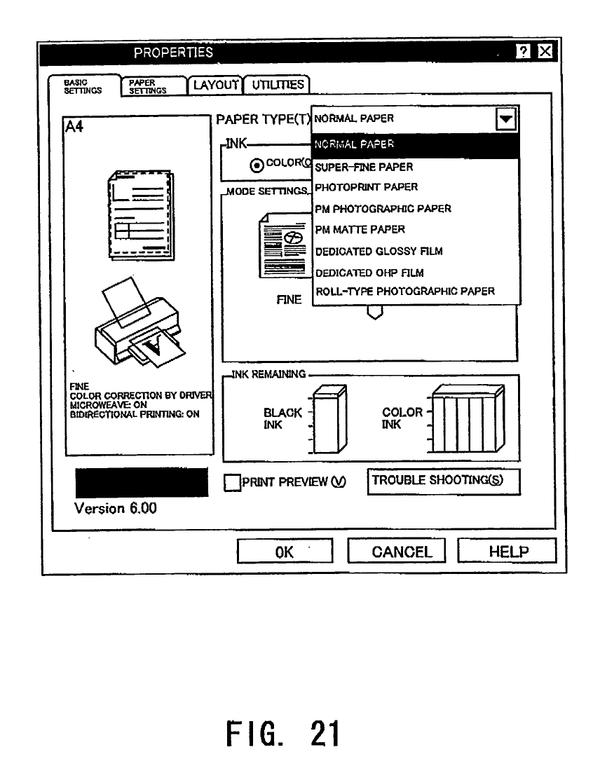

FIG. 21 is an explanatory diagram showing the user interface of a printer driver displayed on the screen of the display device 1104 connected to the computer system. The user can use the input device 1108 to change the various settings of the printer driver.

The user can select the print mode from this screen. For example, the user can select as the print mode a quick print mode or a fine print mode (interlace print mode, overlap print mode). From this screen the user can also select the dot spacing (resolution) when printing. For example, from this screen the user can select 720 dpi or 1440 dpi as the print resolution. The above-mentioned paper carry amount Y (target print start position) is determined based on the print mode that is selected here.

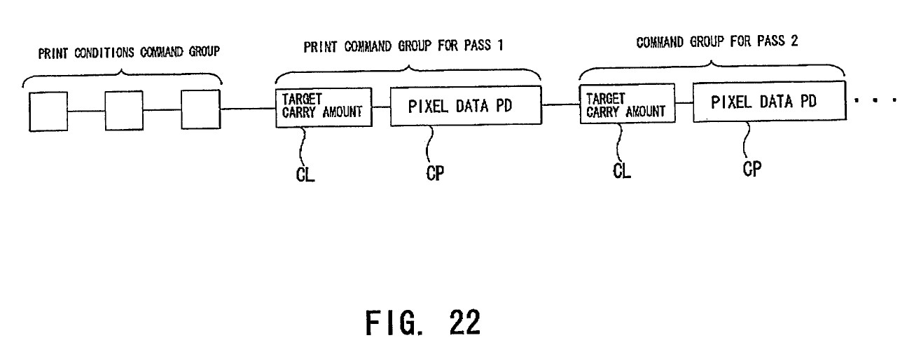

FIG. 22 is an explanatory diagram of the format of the print data supplied from the main computer unit 1102 to the printer 1106. The print data are created from image information based on the settings of the printer driver. The print data have a print condition command group and pass command groups. The print condition command group includes a command indicating the print resolution and a command indicating the print direction (single direction/bidirectional), for example. The print command group for each pass include a target carry amount command CL and a pixel data command CP. The pixel data command CP includes pixel data PD indicating the recording status for each pixel of the dots recorded in that pass. It should be noted that the various commands shown in the diagram each have a header section and a data section; however, here they are shown simplified. Also, these command groups are supplied intermittently to the printer side from the main computer unit side for each command. The print data are not limited to this format, however.

It should be noted that in the above description, an example was described in which the computer system is constituted by connecting the printer 1106 to the main computer unit 1102, the display device 1104, the input device 1108, and the reading device 1110; however, this is not a limitation. For example, the computer system can be made of the main computer unit 1102 and the printer 1106, or the computer system does not have to be provided with any one of the display device 1104, the input device 1108, and the reading device 1110. It is also possible for the printer 1106 to have some of the functions or mechanisms of the main computer unit 1102, the display device 1104, the input device 1108, and the reading device 1110. As an example, the printer 1106 may be configured so as to have an image processing section for carrying out image processing, a display section for carrying out various types of displays, and a recording media attachment/detachment section to and from which recording media storing image data captured by a digital camera or the like are inserted and taken out.

In the embodiment described above, it is also possible for the computer program for controlling the printer to be incorporated in the memory 65, which is the storage medium of the control unit 60. Also, the control unit 60 may execute the computer program stored in the memory 65 so as to achieve the operations of the printer in the embodiment described above.

As an overall system, the computer system that is thus achieved is superior to conventional systems.

===Other Embodiments===

The foregoing embodiment described primarily a printer. However, it goes without saying that the foregoing description also includes the disclosure of printing apparatuses, printing methods, programs, storage media, computer systems, display screens, screen display methods, methods for manufacturing printed material, recording apparatuses, and devices for ejecting liquids, for example.

Also, a printer, for example, serving as an embodiment was described above. However, the foregoing embodiment is for the purpose of elucidating the present invention and is not to be interpreted as limiting the present invention. The invention can of course be altered and improved without departing from the gist thereof and includes functional equivalents. In particular, the embodiments mentioned below are also included in the invention.

<Regarding the Recording Apparatus>

A printer (printing apparatus) was described as a recording apparatus in the foregoing embodiment. However, this is not a limitation. For example, technology like that of the present embodiment can also be adopted for various types of recording apparatuses that use inkjet technology, including color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, and DNA chip manufacturing devices. Also, these methods and manufacturing methods fall within the scope of application. Even when the present technology is adopted in these fields, the fact that liquid can be directly ejected (directly written) to a target object allows a reduction in material, process steps, and costs compared to conventional cases to be achieved.

<Regarding the Ink>

Since the foregoing embodiment was an embodiment of a printer, a dye ink or a pigment ink was ejected from the nozzles. However, the liquid that is ejected from the nozzles is not limited to such inks. For example, it is also possible to eject from the nozzles a liquid (including water) including metallic material, organic material (particularly macromolecular material), magnetic material, conductive material, wiring material, film-formation material, electronic ink, processed liquid, and genetic solutions. A reduction in material, process steps, and costs can be achieved if such liquids are directly ejected toward a target object.

<Regarding the Nozzles 1>

In the foregoing embodiment, ink was ejected using piezoelectric elements. However, the method for ejecting liquid is not limited to this. Other methods may also be employed, such as a method for generating bubbles in the nozzles using heat.

<Regarding the Nozzles 2>

In the foregoing embodiment, the number of nozzles in the nozzle groups for the various colors was 180 nozzles. However, it goes without saying that there is no limit to the number of nozzles being 180 nozzles.

Moreover, in the foregoing embodiment, the downstream side supra-groove nozzle group Nr was constituted by nozzles #1 to #25, However, the downstream side supra-groove nozzles Nr are of course not limited to these.

<Regarding the Paper Carrying Unit>

In the foregoing embodiment, the paper carrying unit, using a PF motor constituted by a DC motor as its drive source, carried the paper while controlling the amount of rotation of the carry roller with the rotary encoder. However, the paper carrying unit it not limited to this configuration, and it may be configured differently, such as a configuration in which a pulse motor or the like is used as the drive source. In other words, it is only necessary that the paper carrying unit is configured to function as a paper carrying mechanism for carrying paper.

<Regarding the Paper Width Sensor>

In the foregoing embodiment, the front end of the paper was detected using a paper width sensor. However, detection of the front end of the paper is not limited to detection using the paper width sensor. For example, it is also possible to provide a separate sensor for detecting the front end of the paper. In other words, it is only necessary that the front end of the paper is detected and that the results of that detection can be used.

<Regarding the Paper Detection Sensor>

In the foregoing embodiment, the paper detection sensor was a mechanical sensor. However, the paper detection sensor can also be an optical sensor.

Also, in the foregoing embodiment, to accurately position the front end of the paper, positioning of the paper was carried out based on the results of detection by the paper width sensor. However, if the front end of the paper can be positioned above the downstream side groove, then the paper can also be carried based on the results of the detection by the paper detection sensor.

<Regarding the Linear Encoder>

In the foregoing embodiment, the position of the carriage in the scanning direction was detected by the linear encoder. However, detection of the position of the carriage is not limited to this. For example, the carriage motor may be a pulse motor and the position of the carriage may be measured based on the number of pulses imparted to the motor.

<Regarding the Print Mode>

In the foregoing embodiment, interlace printing and overlap printing were described. However, the print mode is of course not limited to these print modes.

For example, the print mode may also be band printing. Here, “band printing” is used to mean a print mode in which the nozzle pitch is equal to the dot spacing (k=1) and a plurality of continuous raster lines are printed in a single pass. It should be noted that “pass” refers to a single scan in which the nozzles are moved in the scanning direction. Also, “raster lines” are the rows (dot rows) of pixels lined up in the scanning direction, and are also referred to as scan lines. “Pixels” are the square grids that are determined in a virtual manner on the medium to be printed in order to define the positions where ink droplets land and to record dots. Also, the plurality of raster lines that are printed in a single pass are referred to as a “band,” and the width of the plurality of raster lines is referred to as the “band width.” In band printing, the paper S is carried intermittently at a carry amount that is equal to the band width. In the case of band printing, when the paper has been carried to the print start position, the front end of the paper is in opposition to nozzle #1 (or a position upstream of this position).

The print mode may also be pseudo band printing. Here, “pseudo band printing” means a print mode in which k is at least 2 and printing is carried out in pseudo bands. It should be noted that a pseudo band refers to a plurality of continuous raster lines printed in a plurality of passes. That is, with pseudo band printing, the amount that the paper is carried when printing a pseudo band is the dot pitch D, and the target carry amount after the pseudo band has been completed is the pseudo band width (more specifically, the quantity obtained by subtracting (k−1)·D from the pseudo band width). In the case of pseudo band printing, when the paper has been carried to the print start position, the front end of the paper is in opposition to nozzle #1 (or a position upstream of this position).

<Regarding Carry Error>

In the foregoing embodiment, the target print start position was determined without hardly any consideration given to the carry error. However, the amount that the paper is carried includes error with respect to the target carry amount. Consequently, the target print start position (paper carry amount Y) described above must be set anticipating carry error.

If there is a risk that the paper carry amount will diverge from the target carry amount by roughly the amount of the nozzle pitch, then when positioning the front end of the paper at the position in opposition to nozzle #19, the position in opposition to nozzle #20 can be made the target position. This is because due to the carry error, when the front end of the paper is positioned downstream of the nozzle #19, a margin portion is formed at the front end of the paper S when the paper S is printed. Conversely, if the front end of the paper is positioned upstream of the nozzle #19, then the ink droplets ejected from the nozzles land only in the groove, and thus the paper S can be printed without a margin portion being formed at the front end of the paper.

In this manner, when there is carry error during carrying of the paper, the position of the front end of the paper S when the paper S has been carried furthest downstream is made the target print start position.

Although the preferred embodiment of the present invention has been described in detail, it should be understood that various changes, substitutions and alterations can be made therein without departing from spirit and scope of the inventions as defined by the appended claims.

What is claimed is:

1. A recording method for recording according to one of a plurality of recording modes, comprising the steps of:
S determining a target record start position according to said recording mode;
carrying a front end of a medium to be recorded up to said target record start position that has been determined according to said recording mode;
intermittently carrying said medium to be recorded by a carry amount according to said recording mode; and
carrying out recording to said front end.

2. A recording method according to claim 1, further comprising the steps of:
detecting said front end of said medium to be recorded; and
carrying said medium to be recorded based on a result of the detection of said front end of said medium to be recorded.

3. A recording method according to claim 2, wherein:
said medium to be recorded is carried by a roller of a carrying mechanism;
said front end of said medium to be recorded is detected by a detector; and
said detector is provided downstream of said roller.

4. A recording method according to claim 2, wherein
said front end is detected after skew of said medium to be recorded has been corrected.

5. A recording method according to claim 3, wherein
said detector is provided in/on a carriage that makes a plurality of nozzles move in a scanning direction.

6. A recording method according to claim 1, wherein
said medium to be recorded is supported by a support section that has a recessed section and a protruding section and that supports said medium to be recorded by said protruding section.

7. A recording method according to claim 6, wherein
when carrying out recording to said front end, said target record start position is located between said recessed section and nozzles that are arranged in opposition to said recessed section.

8. A recording method according to claim 1, wherein
one of said recording modes is a mode in which:
a spacing in the carrying direction between two nozzles, among a plurality of nozzles, for ejecting liquid is wider than a spacing in the carrying direction between two dots, among a plurality of dots, formed on said medium to be recorded; and
a row of dots that is not recorded exists between rows of dots that are recorded as said nozzles are moved once in a scanning direction.

9. A recording method according to claim 1, wherein
one of said recording modes is a recording mode in which one dot row formed on said medium to be recorded is recorded using a plurality of nozzles.

10. A recording method according to claim 1, wherein
printing is carried out to said medium to be recorded by carrying out recording to said medium to be recorded.

11. A printing method for printing according to one of a plurality of print modes, comprising the steps of:
determining a target print start position according to said print mode;
carrying a front end of a medium to be printed up to said target print start position determined according to said print mode;
intermittently carrying said medium to be printed by a carry amount according to said print mode;
carrying out printing to said front end;
detecting said front end of said medium to be printed; and
carrying said medium to be printed based on a result of the detection of said front end of said medium to be printed, wherein:
said medium to be printed is carried by a roller of a carrying mechanism;
said front end of said medium to be printed is detected by a detector;
said detector is provided downstream of said roller;
said front end is detected after skew of said medium to be printed has been corrected;
said detector is provided in/on a carriage that makes a plurality of nozzles move in a scanning direction;
said medium to be printed is supported by a support section that has a recessed section and a protruding section and that supports said medium to be printed by said protruding section;
when carrying out printing to said front end, said target print start position is located between said recessed section and nozzles that are arranged in opposition to said recessed section;
one of said print modes is a mode in which a spacing in the carrying direction between two nozzles, among a plurality of nozzles, for ejecting liquid is wider than a spacing in the carrying direction between two dots, among a plurality of dots, formed on said medium to be printed, and a row of dots that is not printed exists between rows of dots that are printed as said nozzles are moved once in said scanning direction; and
another of said print modes is a print mode in which one dot row formed on said medium to be printed is printed using a plurality of nozzles.

12. A recording apparatus capable of recording according to a plurality of recording modes, comprising
a carrying mechanism for carrying a medium to be recorded, wherein said recording mechanism
carries a front end of said medium to be recorded up to a target record start position using said carrying mechanism,
intermittently carries said medium to be recorded by a carry amount according to said recording mode using said carrying mechanism, and
performs recording to said front end, and
wherein said target record start position is determined according to said recording mode.

13. A computer-readable storage medium on which is recorded a program for making a recording apparatus
that is capable of recording according to a plurality of recording modes and
that comprises a carrying mechanism for carrying a medium to be recorded, said recording mechanism
carrying a front end of said medium to be recorded up to a target record start position using said carrying mechanism,
intermittently carrying said medium to be recorded by a carry amount according to said recording mode using said carrying mechanism, and
performing recording to said front end,
realize a function of determining said target record start position according to said recording mode.

14. A computer system comprising:
a computer; and
a recording apparatus,
wherein said recording apparatus:
is capable of recording according to a plurality of recording modes;
determines a target record start position according to a recording mode among said recording modes; and
carries a front end of a medium to be recorded up to said target record start position, and then intermittently carries said medium to be recorded by a carry amount according to said recording mode, and carries out recording to said front end.

15. A recording apparatus comprising:
a carrying mechanism for carrying a medium to be recorded in a carrying direction; and
a support section that has a recessed section and a protruding section and that supports said medium to be recorded by said protruding section, wherein:
said recording apparatus is capable of recording to a front end, in said carrying direction, of said medium to be recorded according to a plurality of recording modes;
when recording to said front end, recording is carried out using a plurality of nozzles that are arranged in opposition to said recessed section; and
the nozzles used when starting recording to said front end are determined according to said recording mode.

16. A recording apparatus according to claim 15, wherein
after said front end of said medium to be recorded has been recorded, recording is carried out with respect to said medium to be recorded using the plurality of nozzles that are arranged in opposition to said recessed section and a plurality of nozzles that are arranged in opposition to said protruding section.

17. A recording apparatus according to claim 16, wherein, between
an operation of intermittently carrying said medium to be recorded by a first carry amount and performing recording between those intermittent carries using the plurality of nozzles that are arranged in opposition to said recessed section, and
an operation of intermittently carrying said medium to be recorded by a second carry amount and performing recording between those intermittent carries using the plurality of nozzles that are arranged in opposition to said recessed section and the plurality of nozzles that are arranged in opposition to said protruding section,
there is an operation of intermittently carrying said medium to be recorded by said first carry amount and performing recording between those intermittent carries using the plurality of nozzles that are arranged in opposition to said recessed section and the plurality of nozzles that are arranged in opposition to said protruding section.

18. A recording apparatus according to claim 15, wherein:
said recording apparatus carries out recording to said medium to be recorded by repeating in alternation a carry operation in which said carrying mechanism carries said medium to be recorded and a recording operation in which liquid is ejected from said nozzles to form dots on said medium to be recorded; and
a carry amount by which said carrying mechanism carries said medium to be recorded when recording to said front end is wider than a spacing in the carrying direction between said dots.
